(19) United States
(12) Patent Application Publication
(10) Pub. No.: US 2016/0299580 A1
(43) Pub. Date: Oct. 13, 2016

(54) ELECTRONIC DEVICE AND METHOD FOR PROVIDING USER INTERFACE THEREOF

(71) Applicant: Samsung Electronics Co., Ltd., Gyeonggi-do (KR)

(72) Inventors: Sang-Chul KU, Gyeonggi-do (KR); Do-Hyoung CHUNG, Seoul (KR); Chang-Soo KIM, Seoul (KR); Jeong-Min PARK, Gyeonggi-do (KR)

(21) Appl. No.: 15/093,396

(22) Filed: Apr. 7, 2016

(30) Foreign Application Priority Data
Apr. 10, 2015 (KR) 10-2015-0051191

(51) Int. Cl. G06F 3/0346; G06F 1/16; G06F 3/0484; G06F 3/01

(52) U.S. Cl. CPC G06F 3/0346; G06F 3/017; G06F 1/163; G06F 3/0484

(57) ABSTRACT

An electronic device and a method for the electronic device to provide a user interface are provided. The electronic device includes a sensor unit configured to detect user motion-based sensor values associated with a plurality of predefined user motions; and a controller configured to classify a wear type of a user into a plurality of predefined groups based on the detected user motion-based sensor values, determine, as the wear type of the user, a predefined wear type that is commonly included in each of the predefined groups into which the wear type of the user is classified, and to control a change of a user interface based on the determined wear type of the user.

### PRIORITY

This application claims priority under 35 U.S.C. §119(a) to Korean Application Serial No. 10-2015-0051191, which was filed in the Korean Intellectual Property Office on Apr. 10, 2015, the entire content of which is incorporated herein by reference.

### BACKGROUND

1. Field of the Invention

The present invention relates generally to an electronic device, and more particularly to a method and apparatus for providing a user interface in the electronic device.

2. Description of the Related Art

An electronic device is a device which performs a predetermined function corresponding to an installed program, such as a home appliance, an electronic scheduler, a portable multimedia player, a mobile communication terminal, a tablet Personal Computer (PC), a video/audio device, a desktop/laptop computer, a navigation unit for a vehicle, and the like. For example, electronic devices may output stored information via sound or images. With the increase of degree of integration and the popularization of hyper-speed and high capacity wireless communication, mobile communication terminals having various functions have been recently developed. For example, an entertainment function, such as a game, a multimedia function, such as reproduction of a music file and a video file, a communication and security function for mobile banking or the like, a scheduling function, an electronic wallet function, etc. can be integrated into a single electronic device such as a mobile communication terminal, in addition to a communication function.

Portable electronic devices, such as an electronic scheduler, a portable multimedia player, a mobile communication terminal, a tablet PC, or the like, may contain a flat display device and a battery, and may be provided in the shape of, for example, a bar type, a folder type, or a sliding type. Recently, as electronic communication technologies have developed, the size of electronic devices has decreased. Accordingly, electronic devices that can be worn by a body part, such as a wrist, a head, or the like, which are called wearable electronic devices, have become commercialized.

A band-type wearable electronic device, such as a conventional smart watch, provides a user interface in a predetermined direction, and thus, a user must wear the electronic device in a predetermined orientation.

Particularly, it may be difficult for a user to identify the top and bottom sides and the right and left sides of a smart watch, due to its appearance, or when guidance associated with a direction (i.e., orientation) for wearing the device is not provided, the user may not easily recognize a proper direction for wearing the device. Conversely, when guidance for the direction for wearing the device is provided, the freedom of selecting a manner in which the user can choose to wear the device is not considered. Also, when the user does not wear the electronic device in the predetermined manner, or when the direction of the electronic device is changed (e.g., the direction is changed moving the device from the right hand to the left hand), the user must manually reset the direction of a display, which is inconvenient. Also, when the user is required to input a desired wear direction, it may be burdensome for the user to accurately set the corresponding information.

### SUMMARY

The present invention has been made to address at least the above problems and/or disadvantages and to provide at least the advantages described below. Accordingly, an aspect of the present invention is to provide an electronic device and a method for the electronic device to provide a user interface that automatically displays a user interface that is changed based on a direction of the electronic device that the user wears, so that the user is not required to recognize the direction in advance and/or a guidance associated with the direction for wearing the device is not required and thus, user convenience may be improved.

According to an aspect of the present invention, an electronic device is provided. The electronic device includes a sensor unit configured to detect user motion-based sensor values associated with a plurality of predefined user motions; and a controller configured to classify a wear type of a user into a plurality of predefined groups based on the detected user motion-based sensor values, determine, as the wear type of the user, a predefined wear type that is commonly included in each of the predefined groups into which the wear type of the user is classified, and to control a change of a user interface based on the determined wear type of the user.

According to another aspect of the present invention, a method for an electronic device to provide a user interface is provided. The method includes detecting user motion-based sensor values associated with a plurality of predefined user motions; classifying a wear type of a user into a plurality of predefined groups of a plurality of predefined wear types based on the detected user motion-based sensor values; determining, as the wear type of the user, a predefined wear type that is commonly included in each of the predefined groups into which the wear type of the user is classified; and changing a user interface changed based on the determined wear type of the user.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a diagram illustrating a network environment according to an embodiment of the present invention;

FIG. 2 is a block diagram illustrating a display controller of an electronic device according to an embodiment of the present invention;

FIG. 3 is a diagram illustrating examples of a wear type of an electronic device according to an embodiment of the present invention;

FIG. 4 is a diagram illustrating an example of a reference direction of an electronic device according to an embodiment of the present invention;

FIGS. 5A through 5D are diagrams illustrating examples of user interface settings based on a wear type of an electronic device according to an embodiment of the present invention;

FIG. 6 is a flowchart illustrating a user interface providing method of an electronic device according to an embodiment of the present invention;

FIGS. 7A and 7B are diagrams illustrating examples of a user motion used for deciding a wear type of an electronic device according to an embodiment of the present invention;

FIGS. 8A and 8B are diagrams illustrating examples of a user motion used for deciding a wear type of an electronic device according to an embodiment of the present invention;

FIGS. 9A through 9C are flowcharts illustrating a process of deciding and determining a wear type of FIG. 6 according to an embodiment of the present invention;

FIG. 10 is a block diagram of an electronic device according to various embodiments of the present invention; and

FIG. 11 illustrates a communication protocol among a plurality of electronic devices according to an embodiment of the present invention.

### DETAILED DESCRIPTION OF EMBODIMENTS OF THE INVENTION

Hereinafter, various embodiments of the present invention are described with reference to the accompanying drawings. Embodiments of the present invention described herein may be modified in accordance with embodiments of the present invention. Therefore, although specific examples are illustrated in the drawings and described herein, the description does not limit embodiments of the present invention to these specific embodiments, and all the changes, equivalents and substitutions corresponding to the idea and technical scope of the present invention are included in the present invention. In the drawings, similar reference numerals may be used to designate the same or similar elements.

The terms “include” and “may include” refer to the existence of a corresponding disclosed function, operation, or component that can be used in accordance with various embodiments of the present invention, and does not limit the possibility of additional functions, operations, or components. Herein, terms such as “include” or “have” refer to a certain characteristic, number, step, operation, constituent element, component or a combination thereof, but do not exclude the existence of or a possibility of addition of one or more other characteristics, numbers, steps, operations, constituent elements, components or combinations thereof.

The term “or”, as used herein, includes any or all of combinations of listed words. For example, the expression “A or B” may include A, may include B, or may include both A and B.

Expressions such as “first”, “second”, etc., as used herein, may modify various component elements, but do not limit corresponding component elements. For example, the above expressions do not limit the sequence and/or importance of the elements. The above expressions are used merely for the purpose of distinguishing an element from other elements. For example, a first user device and a second user device indicate different user devices although both are user devices. For example, a first component element may be designated as a second component element. Similarly, the second component element also may be designated as the first component element.

If a component element is “coupled” or “connected” to another component element, the first component element may be directly coupled or connected to the second component, and a third component element may be “coupled” or “connected” between the first and second component elements. Conversely, when a first component element is “directly coupled” or “directly connected” to a second component element, a third component element does not exist between the first component element and the second component element.

The terms in various embodiments of the present invention are used to describe specific embodiments of the present invention, and do not limit embodiments of the present invention. Herein, singular forms may include plural forms as well unless the context clearly indicates otherwise.

Unless defined differently, all terms used herein, which include technical terminologies or scientific terminologies, have the same meaning as a person skilled in the art to which the present invention belongs. Such terms as those defined in a generally used dictionary are to be interpreted to have definitions equivalent to the contextual definitions in the relevant field of art, and are not to be interpreted to have ideal or excessively formal meanings, unless clearly defined herein.

An electronic device according to various embodiments of the present invention may be, but is not limited to, a device including a posture determination function or a motion sensing function. For example, the electronic device may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an Motion Picture Experts Group (MPEG) Audio Layer 3 (MP3) player, a mobile medical device, a camera, a wearable device (e.g., a Head-Mounted-Device (HMD) such as electronic glasses, electronic clothes, an electronic bracelet, an electronic necklace, an electronic appcessory, an electronic tattoo, and a smart watch.

According to some embodiments of the present invention, an electronic device may be a smart home appliance having a posture determination function or a motion sensing function. For example, the smart home appliance may include at least one of a television, a Digital Video Disk (DVD) player, an audio, a refrigerator, an air conditioner, a vacuum cleaner, an oven, a microwave oven, a washing machine, an air cleaner, a set-top box, a TeleVision TV box (e.g., Samsung HomeSync™, Apple TV™, or Google TV™), a game console, an electronic dictionary, an electronic key, a camcorder, and an electronic photo frame.

According to some embodiments of the present invention, the electronic device may include a medical appliance (e.g., Magnetic Resonance Angiography (MRA), Magnetic Resonance Imaging (MRI), Computed Tomography (CT), and ultrasonic machines), navigation equipment, a Global Positioning System (GPS) receivers, an Event Data Recorder (EDR), a Flight Data Recorder (FDR), automotive infotainment device, electronic equipment for ships (e.g., ship navigation equipment and a gyrocompass), avionics, security equipment, a vehicle head unit, an industrial or home robot, an Automatic Teller Machine (ATM) of a banking system, and a Point Of Sales (POS) of a shop.

According to some embodiments of the present invention, the electronic device may include at least one of a part of furniture or a building/structure, an electronic board, an electronic signature receiving device, a projector, and various kinds of measuring instruments (e.g., a water meter, an electric meter, a gas meter, or a radio wave meter), all of which have a posture determination function or a motion sensing function. An electronic device according to various embodiments of the present invention may be a combination of one or more of above described various devices. Also, an electronic device according to various embodiments of the present invention may be a flexible device. Also, an electronic device according to various embodiments of the present invention is not limited to the above described devices.

Hereinafter, electronic devices according to various embodiments of the present invention are described with reference to the accompanying drawings. The term “user” as used in various embodiments of the present invention may indicate a person who uses an electronic device or a device (e.g., artificial intelligence electronic device) that uses an electronic device.

Herein, the term “wear type” refers to the manner in which a wearable device is worn by the user, such as the orientation of the device relative to a particular part or parts of a user's body.

According to an embodiment of the present invention, when the number of wear types is 2², the number of predetermined plurality of user motions is determined to be 2. The plurality of wear types include:
a first type in which the electronic device is worn on the left outer wrist to enable a first axis of the electronic device to face towards the fingers of the user's left hand,
a second type in which the electronic device is worn on the right outer wrist to enable the first axis to face towards the fingers of the user's left hand,
a third type in which the electronic device is worn on the left outer wrist to enable the first axis to face toward a left arm of the left wrist upon which the user device is worn, and
a fourth type in which the electronic device is worn on the right outer wrist to enable the first axis to face towards a right arm of the right wrist upon which the user device is worn.

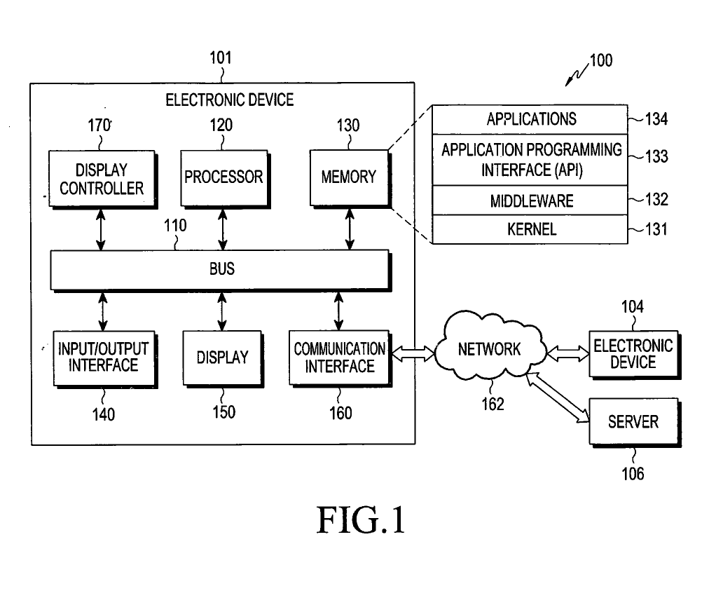

FIG. 1 illustrates a network environment including an electronic device according to an embodiment of the present invention.

Referring to FIG. 1, a network environment 100 includes an electronic device 101 which includes a bus 110, a processor 120, a memory 130, an input/output interface 140, a display 150, a communication interface 160, and a display controller 170.

The bus 110 is a circuit that connects the above-described component elements with each other and transfers communications (e.g., control messages) among the above-described component elements.

The processor 120 receives commands from other component elements (e.g., the memory 130, the input/output interface 140, the display 150, the communication interface 160, the display controller 170, or the like) through, for example, the bus 110, analyzes the received commands, and executes calculation or data processing according to the analyzed commands.

The memory 130 stores commands or data received from or generated by the processor 120 or other component elements as described above. The memory 130 includes programming modules for example, a kernel 131, a middleware 132, an Application Programming Interface (API) 133, an application 134, or the like. Each of the aforementioned programming modules may be formed of software, firmware, hardware, or a combination of at least two thereof.

The kernel 131 controls or manages system resources (e.g., the bus 110, the processor 120, the memory 130, or the like) used to execute operations or functions implemented by the other remaining programming modules (e.g., the middleware 132, the API 133, and the application 134). Furthermore, the kernel 131 provides an interface through which the middleware 132, the API 133, and the application 134 access individual component elements of the electronic device 101 to control or manage the individual component elements.

The middleware 132 serves as an intermediary, such that the API 133 or the application 134 communicates with the kernel 131 to transmit/receive data. Further, in relation to task requests received from the applications 134, the middleware 132 controls (e.g., scheduling or load-balancing) the requests using, for example, a method of assigning a priority for using system resources (e.g., the bus 110, the processor 120, the memory 130, or the like) of the electronic device 101, to at least one application among the applications 134.

The API 133 is an interface by which the applications 134 control functions provided from the kernel 131 or the middleware 132, and may include, for example, at least one interface or function (e.g., instructions) for file control, window control, image processing, text control, or the like.

According to an embodiment of the present invention, the applications 134 may include, for example, a Short Message Service (SMS)/Multimedia Message Service (MMS) application, an e-mail application, a calendar application, an alarm application, a health care application (e.g., an application for measuring a work rate or a blood sugar level), an environment information application (e.g., an application for providing atmospheric pressure, humidity, or temperature information), or the like. Additionally or alternately, the application 134 may be an application related to exchanging information between the electronic device 101 and an external electronic device (e.g., an electronic device 104). The application related to exchanging information may include, for example, a notification relay application for transferring predetermined information to the external electronic device, or a device management application for managing the external electronic device.

For example, the notification relay application may include a function of transferring notification information generated in other applications (e.g., the SMS/MMS application, the e-mail application, the health care application, or the environmental information application) of the electronic device 101 to an external electronic device (e.g., the electronic device 104). Additionally or alternately, the notification relay application may, for example, receive notification information from an external electronic device (for example, the electronic device 104), and may provide the received notification information to a user. The device management application may manage (e.g., install, delete, or update), for example, at least some functions (e.g., turning an external electronic device (or some elements of the external electronic device) on or off, or adjusting the brightness (or resolution) of a display) of an external electronic device (for example, the electronic device 104) that communicates with the electronic device 101, applications performed in the external electronic device, or services (e.g., a phone call service, or a messaging service) provided in the external electronic device.

According to embodiments of the present invention, the application 134 may include applications, which are designated according to the property (e.g., the type of electronic device) of the external electronic device (for example, the electronic device 104). For example, when the external electronic device is an MP3 player, the applications 134 may include an application related to the reproduction of music. Similarly, when the external electronic device is a mobile medical device, the applications 134 may include an application related to health care. According to an embodiment of the present invention, the applications 134 may include applications received from an external electronic device (e.g., a server 106 or the electronic device 104), or originally installed in the electronic device 101 when manufactured.

The input/output interface 140 may transmit a command or data input from the user through an input/output device (e.g., sensor, keyboard, or touch screen) to the processor 120, the memory 130, the communication interface 160, or the display controller 170 through, for example, the bus 110. For example, the input/output interface 140 may provide, to the processor 120, data for a user's touch that is input through the touch screen. Also, the input/output interface 1140 may output, through the input/output device (e.g., speaker or display), a command or data received from the processor 120, the memory 130, the communication interface 160, or the display controller 170 through, for example, the bus 110. For example, the input/output interface 140 may output voice data processed by the processor 120 to the user through the speaker.

The display 150 may display various pieces of information (e.g., multimedia data or text data) to the user. Also, the display 150 according to various embodiments of the present invention, may display an input bar or an input pad, through which various characters, numbers, symbols or the like are input, on a screen in various ways.

The communication interface 160 connects communication between the electronic device 101 and an external device (for example, the electronic device 104 or the server 106). For example, the communication interface 160 may be connected with a network 162 through wireless communication or wired communication, so as to communicate with the external electronic device. The wireless communication may include, for example, Wi-Fi, Bluetooth (BT), Near Field Communication (NFC), a Global Positioning System (GPS), and cellular communication (e.g., Long Term Evolution (LTE), Long Term Evolution-Advanced (LTE-A), Code Division Multiple Access (CDMA), Wideband CDMA (WCDMA), Universal Mobile Telecommunication System (UMTS), WIreless BROadband (WiBro), or Global System for Mobile communication (GSM)). The wired communication may include at least one of, for example, a Universal Serial Bus (USB), a High Definition Multimedia Interface (HDMI), Recommended Standard 232 (RS-232), or a Plain Old Telephone Service (POTS).

According to an embodiment of the present invention, the network 162 may be a communication network (telecommunications network). The telecommunications network may include a computer network, Internet, Internet of things, or a telephone network. According to an embodiment of the present invention, a protocol (e.g., a transport lay protocol, data link layer protocol, or a physical layer protocol) for communication between the electronic device 101 and an external device may be supported by at least one of the applications 134, the application programming interface 133, the middleware 132, the kernel 131, and the communication interface 160.

According to an embodiment of the present invention, the server 106 supports driving of the electronic device 101 by performing at least one operation (or function) implemented in the electronic device 101. For example, the server 106 may include a display control server module that supports at least one function of the display controller 170 embodied in the electronic device 101. For example, the display control server module may include at least one component element of the display controller 170, and may execute at least one of the operations that the display controller 170 executes (e.g., may execute at least one of the operations for the display controller 170).

Although the electronic device 101 includes the communication interface 160 to communicate with the external electronic device 104 or the server 106 through the network 162 in FIG. 1, the electronic device 101 may be implemented to independently operate therein without a separate communication function according to various embodiments of the present invention.

The display controller 170 processes at least some of the information obtained from other component elements (e.g., processor 120, memory 130, input/output interface 140, or communication interface 160) of the electronic device 101, and provides the processed information to the user in various ways. For example, the display controller 170 controls at least some functions of the electronic device 101 using the processor 120 or independently, so that the electronic device 101 works together with other electronic devices (e.g., the electronic device 104 or the server 106).

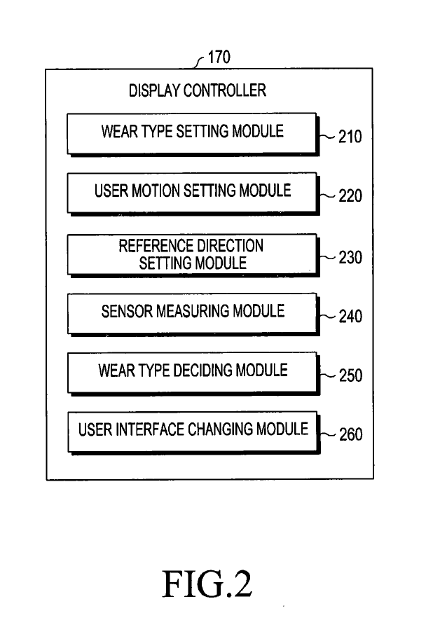

Hereinafter, additional information associated with the display controller 170 is described with reference to FIGS. 2 through 9C.

Although FIG. 1 illustrates the display controller 170 as a separate module from the processor 120, some or all of the display controller 170 may be included in the processor 120, the display 150, or another processor.

FIG. 2 is a block diagram illustrating a display controller of an electronic device according to an embodiment of the present invention.

Referring to FIG. 2, the display controller 170 includes a wear type setting module 210, a user motion setting module 220, a reference direction setting module 230, a sensor measuring module 240, a wear type deciding module 250, and a user interface changing module 260.

The display controller 170 determines a plurality of wear types based on whether user motion-based sensor values, which are detected based on a plurality of predetermined user motions set in advance to identify the plurality of wear types, satisfy at least one condition set in advance for each user motion or to classify the plurality of wear types into a plurality of groups based on the user motions. The display controller also determines, as the wear type of a user, a wear type that is commonly included in the corresponding groups when classification into the plurality of groups is executed, and displays a user interface changed based on the finally decided wear type.

The wear type setting module 210 may be set by the user. The user may set a plurality of wear types based on a wear direction of the electronic device 101 that the user wears.

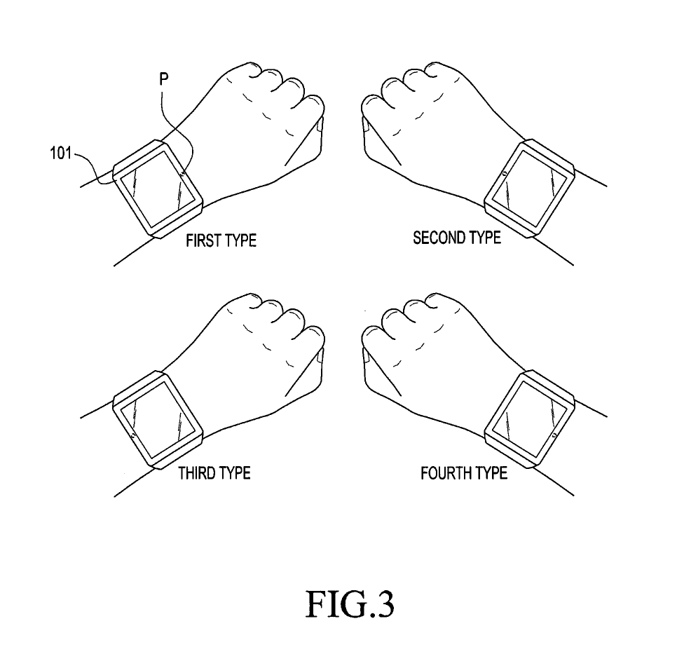

FIG. 3 is a diagram illustrating an electronic device when a user recognizes the wear direction in advance, or a guidance associated with a wear direction is not provided. In this instance, the user may set various wear types of the electronic device 101.

According to an embodiment of the present invention, the wear types are set to include a first type in which the electronic device 101 is worn on the left outer wrist of a user, so that a virtual reference point P faces towards the fingers of the user's left hand, a second type in which the electronic device 101 is worn on the right outer wrist so that the virtual reference point P faces the fingers of the user's right hand, a third type in which the electronic device 101 is worn on the left outer wrist so that the virtual point P faces towards a left arm of the user, and a fourth type in which the electronic device 101 is worn on the right outer wrist so that the virtual reference point P faces the towards a right arm of the user.

According to an embodiment of the present invention, when a predetermined reference point, such as a power button, exists in one side of the electronic device and the top and bottom sides, or the left and right sides, are determined in advance, the wear type may be set to include only two types. For example, when a predetermined reference point (e.g., the virtual reference point P of FIG. 3), such as a power button, exists on the left side of the electronic device 101 and the left and right sides are determined in advance, the user may need to wear the electronic device to enable the reference point to be in the left side, the wear type may be set to include the first type in which the electronic device 101 on is worn on the left outer wrist so that the reference point faces towards the fingers of the user's left hand, and the fourth type in which the electronic device 101 is worn on the right outer wrist so that the reference point faces the towards user's right arm. In the same manner, when the reference point is formed in the right side, the upper side, or the lower side of the electronic device 101, the wear type may be set to include the first type and the fourth type.

Although not illustrated, the user may wear the electronic device 101 on an inner wrist, in the same manner as the first type through the fourth type. As described above, the wear type may not be limited thereto, and the user may set various wear types including other wear types in addition to the described wear types.

The user motion setting module 220 is to set a user motion used for deciding a wear type set in the wear type setting module 210, which may be set by the user. In this instance, the number of set user motions may be determined based on the number of set wear types. That is, the number of set wear types may be expressed as 2ⁿ (here, n is a natural number), and a numeric value corresponding to n may be the number of set user motions. For example, when there are 2 set wear types, the number of the set wear types may be expressed as 2¹, and the number of user motions may be 1. When the number of set wear types is 4, the number of the set wear types may be expressed as 2², and the number of user motions may be 2.

According to an embodiment of the present invention, when four wear types are set, including the first type to the fourth type, two user motions may be set, including a first user motion that lowers a hand upon which the electronic device 101 is worn, and a second user motion (wrist-up motion) that raises a wrist where the electronic device 101 is worn to check a screen.

According to an embodiment of the present invention, when a predetermined reference point (e.g., a location identical to the virtual reference point P of FIG. 3), such as a power button, exists in one side of the electronic device 101 and the top and bottom sides or the left and right sides are determined in advance based on the reference point, when two wear types are set, including the first type and the fourth type, one user motion may be set. This one user motion may include the first user motion that includes lowering a hand where the electronic device 101 is worn or the second user motion (wrist-up motion) that includes raising a wrist where the electronic device 101 is worn to check a screen. The reference direction setting module 230 is to set a reference direction of the electronic device 101, which may be set by the user. The user may set any direction of the electronic device 101 as the reference direction of the electronic device 101. According to an embodiment of the present invention, a wear direction of the first type may be set as the reference direction, a wear direction of the second type may be set as the reference direction, a wear direction of the third type may be set as the reference direction, or a wear direction of the fourth type may be set as the reference direction.

The wear type, the user motion, or the reference direction may be set by the user as described above or may be set in advance. For example, a direction of the electronic device 101, when the electronic device 101 is horizontal, may be set as the reference direction in advance.

The sensor measuring module 240 detects a sensor value (e.g., a trajectory of a movement direction, a rotation direction, a rotation angle, or the like) associated with a user motion set in advance or set by the user motion setting module 220. According to an embodiment of the present invention, the sensor measuring module 240 detects a first sensor value (e.g., a movement trajectory of an x axis) associated with the first user motion, and detects a second sensor value (e.g., a movement trajectory of a y axis) associated with the second user motion. The sensor measuring module 240 may include, for example, an acceleration sensor, a gyroscope, a geomagnetic sensor, an atmospheric pressure sensor, a gesture sensor, an image sensor, or a combination thereof.

The wear type deciding module 250 compares user motion-based sensor values detected by the sensor measuring module 240 in association with a user motion and at least one condition determined in advance for each user motion, so as to decide the plurality of wear types.

The wear type deciding module 250 determines the plurality of wear types based on whether a sensor value detected for each user motion satisfies the at least one condition or classifies the wear types into a plurality of groups based on a user motion, and finally determines, as the wear type of the user, a wear type that is commonly included in corresponding classified groups when classification into the plurality of groups is executed.

According to an embodiment of the present invention, when the number of wear types is 2², the number of predetermined plurality of user motions is determined to be 2. As described herein above, the plurality of wear types include:
a first type in which the electronic device is worn on the left outer wrist to enable a first axis of the electronic device to face towards the fingers of the user's left hand,
a second type in which the electronic device is worn on the right outer wrist to enable the first axis to face towards the fingers of the user's right hand,
a third type in which the electronic device is worn on the left outer wrist to enable the first axis to face toward a left arm of the left wrist upon which the user device is worn, and
a fourth type in which the electronic device is worn on the right outer wrist to enable the first axis to face towards a right arm of the right wrist upon which the user device is worn.

The plurality of user motions that are used to identify whether the wear type is one of the first type to the fourth type may include a first user motion that includes lowering a hand upon which the electronic device is worn and a second user motion that includes raising a wrist upon which the electronic device is worn to check a screen.

In this instance, the wear type deciding module 250 makes a primary decision by classifying the plurality of wear types into a first group and a second group, based on whether a first sensor value detected based on the predetermined first user motion satisfies a first condition or a second condition, makes a secondary decision by classifying the plurality of wear types into a third group and a fourth group based on whether a second sensor value detected based on the predetermined second user motion satisfies a third condition or a fourth condition, and finally decides, as the wear type of the user, a wear type that is commonly included in the primary decision and the secondary decision. This final decision is performed by combining the groups of the primary decision and the groups of the secondary decision.

For example, when the first sensor value is a movement trajectory of the first axis, the first condition is that the movement trajectory of the first axis is a positive value, and the second condition is that the movement trajectory of the first axis is a negative value, in the primary identification, the wear type deciding module 250 decides the wear type of the user as one of the first type and the second type and classifies the wear type as being included in the first group when the first sensor value is a positive value (e.g., 90°), and decides the wear type of the user as being included in the third type or the fourth type and classifies the wear type as the second group when the first sensor value is a negative value (e.g., −90°).

For example, when the second sensor value is a movement trajectory of a second axis that is perpendicular to the first axis, the third condition is that the movement trajectory of the second axis is a positive value, and the fourth condition is that the movement trajectory of the second axis is a negative value, in the secondary identification, the wear type deciding module 250 determines that the wear type of the user is one of the first type and the third type and classifies the wear type as being included in the third group when the second sensor value is a positive value (e.g., 45°), determines that the wear type of the user is one the second type and the fourth type, and classifies the wear type as being included in the fourth group when the second sensor value is a negative value (e.g., −45°).

Subsequently, the wear type deciding module 250:
finally decides that the wear type of the user is the first type when the wear type is classified as being included in the first group in the primary decision, and the wear type is classified as being included in the third group in the secondary decision,
finally decides that the wear type of the user is the second type when the wear type is classified as being included in the first group in the primary decision and the wear type is classified as being included in the fourth group in the secondary decision,
finally decides that the wear type of the user is the third type when the wear type is classified as being included in the second group in the primary decision and the wear type is classified as being included in the third group in the secondary decision, and
finally decides that the wear type of the user is the fourth type when the wear type is classified as being included in the second group in the primary decision and the wear type is classified as the fourth group in the secondary decision.

According to an embodiment of the present invention, when the top and bottom sides or the left and right sides are determined in advance, based on a reference point formed in one side of the electronic device:
the number of the plurality of wear types is determined as 2¹, where the number of the plurality of predetermined user motions is determined as 1, and
the plurality of wear types include the first type in which the electronic device is worn on the left outer wrist to enable the first axis of the electronic device to face towards the fingers of the user's left hand and the fourth type that wears the electronic device on the right outer wrist to enable the first axis to face towards the user's the right arm, and
the plurality of user motions that identify the first type and the fourth type may include the first user motion that lowers a hand where the electronic device is worn.

In this instance, the wear type deciding module 250 may finally decide that the plurality of wear types are the first type or the fourth type, based on whether the first sensor value detected based on the predetermined first user motion satisfies the first condition or the second condition.

For example, when the first sensor value is the movement trajectory of the first axis:
the first condition is that the movement trajectory of the first axis is a positive value, and
the second condition is that the movement trajectory of the first axis is a negative value, the wear type deciding module 250 finally decides the wear type of the user as the first type when the detected first sensor value is a positive value (e.g., 90°), and
finally decides the wear type of the user as the fourth type when the detected first sensor value is a negative value (e.g., −90°).

According to an embodiment of the present invention, when the top and bottom sides or the left and right sides are determined in advance, based on a reference point formed in one side of the electronic device:
the number of the plurality of wear types is determined as 2¹ and the number of the plurality of predetermined user motions is determined as 1,
the plurality of wear types may include the first type that wears the electronic device on the left outer wrist to enable the first axis of the electronic device to face towards the fingers of the user's left hand and the fourth type that wears the electronic device on the right outer wrist to enable the first axis to face towards the user's the right arm, and
the plurality of user motions that identify the first type and the fourth type may include the second user motion that raises a wrist where the electronic device is worn to check a screen.

In this instance, the wear type deciding module 250 may finally decide the plurality of wear types as the first type or the fourth type based on whether the second sensor value detected based on the predetermined second user motion satisfies the third condition or the fourth condition.

For example, when the second sensor value is the movement trajectory of the second axis, which is perpendicular to the first axis, the third condition is that the movement trajectory of the second axis is a positive value, and the fourth condition is that the movement trajectory of the second axis is a negative value, the wear type deciding module 250 finally decides the wear type of the user as the first type when the detected second sensor value is a positive value (e.g., 45°) and finally decides the wear type of the user as the fourth type when the detected second sensor value is a negative value (e.g., −45°).

The user interface changing module 260 may be set by the user. The user interface changing module 260 may set a user interface that is to be changed based on the wear type finally decided by the wear type deciding module 250. According to an embodiment of the present invention, the user interface changing module 260 sets a screen direction, a location of an input button, selecting the left hand/right hand during a motion of raising a wrist to check a screen, a swipe direction, or the like, to be changed based on the wear type.

The display 150 of the electronic device 101 displays, on a screen, a user interface of which settings are changed based on the plurality of wear types.

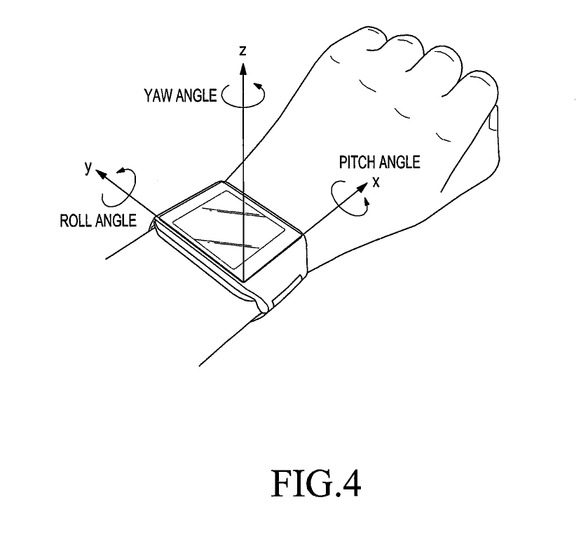

FIG. 4 is a diagram illustrating an example of a reference direction of an electronic device according to an embodiment of the present invention.

Referring to FIG. 4, a reference direction of the electronic device 101 includes three axes (e.g., x axis, y axis, and z axis) directions that are perpendicular to one another, and a rotation angle that rotates about each axis. The electronic device 101 may set a wear direction of the first type when the electronic device 101 is horizontally-oriented as a reference direction. For example, the electronic device 101 may include an x axis in a direction that goes from the left side of a screen to the right side, a y axis in a direction that goes from the bottom side of the screen to the top side, and a z axis that is perpendicular to a plane formed of the x axis and the y axis and is in a direction that goes from the screen to an upper side. Here, a rotation angle that rotates about the x axis is referred to as a pitch angle, a rotation angle that rotates about the y axis is referred to as a roll angle, and a rotation angle that rotates about the z axis is referred to as a yaw angle. The direction of each axis and each rotation angle may vary based on the wear type of the user.

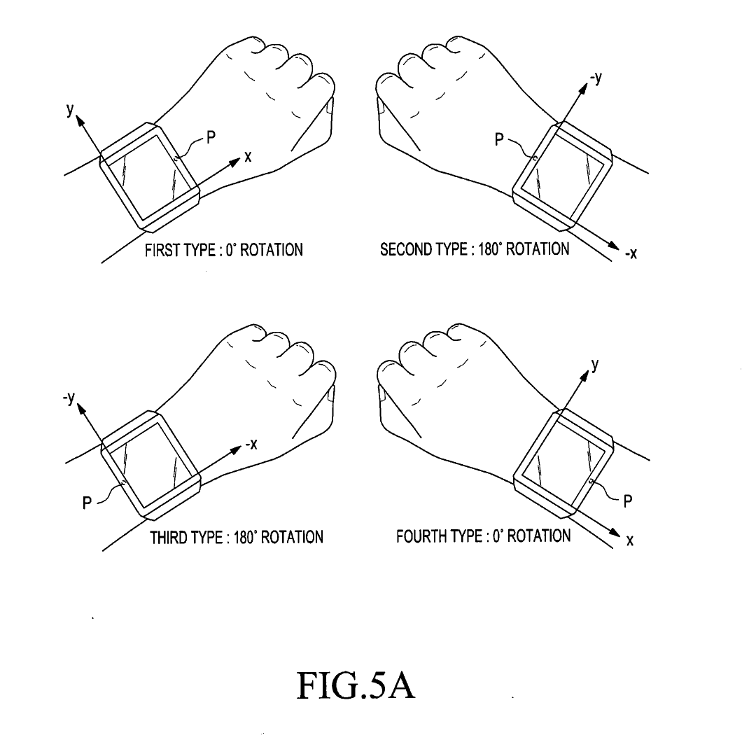

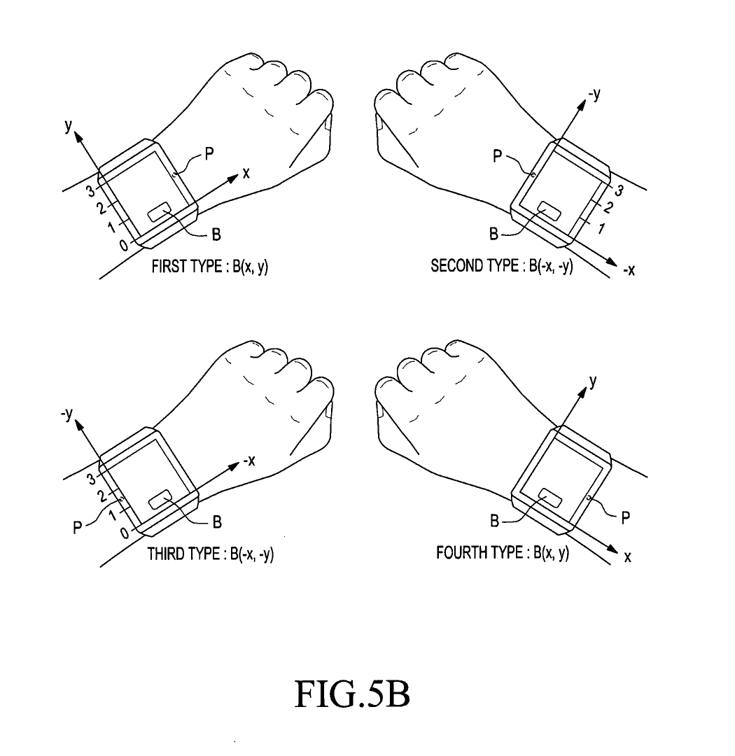

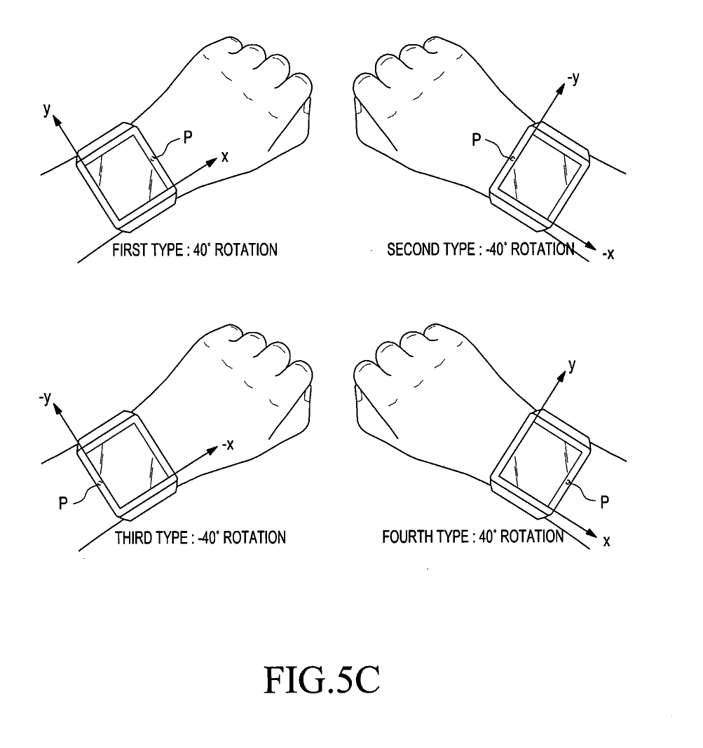

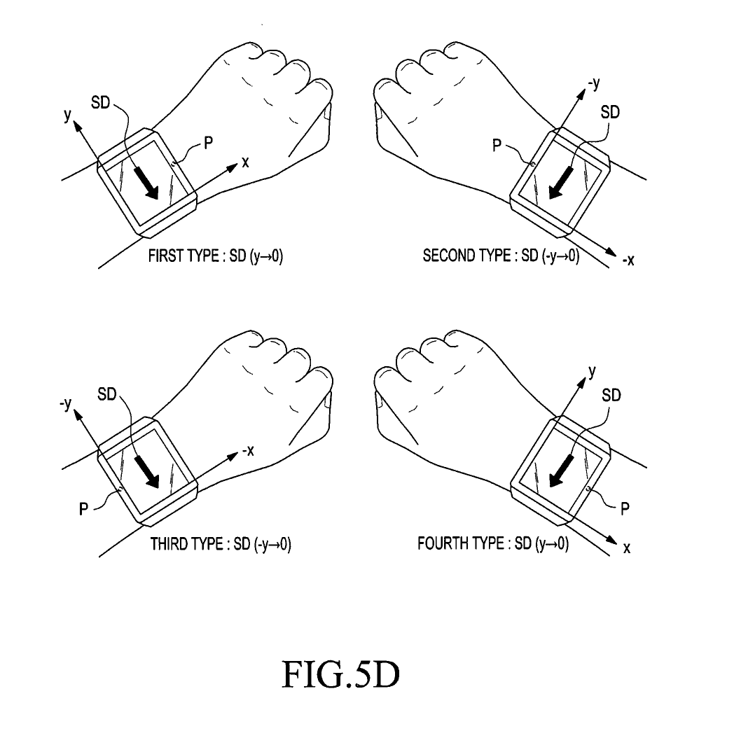

FIGS. 5A through 5D are diagrams illustrating examples of user interface settings based on the wear type of an electronic device according to an embodiment of the present invention. In the following example, it is assumed that a reference direction is set to be identical to the first type, and a direction that is opposite to each axis direction is expressed as a minus (−).

Referring to FIG. 5A, a user sets a screen rotation of the display 150 based on the wear type of the user. For example, when the user wears the electronic device in the wear direction of the first type, the screen of the display 150 may be set to not be rotated (0° Rotation). When the user wears the electronic device in the wear direction of the second type, each axis is reversed to become opposite to the reference direction and thus, the screen of the display 150 is set to be rotated in a direction opposite to the first type (180° Rotation). When the user wears the electronic device in the wear direction of the third type, each axis is reversed to become opposite to the reference direction and thus, the screen of the display 150 may be set to be rotated in a direction opposite to the first type (180° Rotation). For example, when the user wears the electronic device in the wear direction of the fourth type, each axis is in the reference direction that is identical to the first type, and thus, the screen of the display 150 may be set to not be rotated (0° Rotation).

Referring to FIG. 5B, the user may set a location of an input button based on the wear type of the user. In the following example, the input button is a back-button B. For example, when the user wears the electronic device in the wear directions of the first type, the user may set the back-button B to be located in a direction (x, y) close to the body and between 0 and 1 in the y axis. When the user wears the electronic device in the wear direction of the second type, the user may set the back-button B to be located in a direction (−x, −y) close to the body and between 0 and −1 in the y axis. When the user wears the electronic device in the wear direction of the third type, the user may set the back-button B to be located in a direction (−x, −y) close to the body and between 0 and −1 in the y axis, in the same manner as the second type. When the user wears the electronic device in the wear direction of the fourth type, the user may set the back-button B to be located in a direction (x, y) close to the body and between 0 and 1 in the y axis, in the same manner as the first type.

Referring to FIG. 5C, the user may set the left/right hand settings during a motion (wrist-up motion) that raises a wrist to check the screen based on the wear type. Here, when the rotation direction of a rotation angle of each axis is a counterclockwise direction, it is expressed as a minus (−). Also, in the present example, the screen of the electronic device 101 is tilted about 40 degrees to the bottom side from the horizontal plan during the wrist-up motion that raises a wrist to check the screen. For example, when the user makes a wrist-up motion that raises a wrist to check the screen, and a pitch angle of the x axis is about 40 degrees (a movement trajectory of the y axis rotates clockwise), the left hand or the right hand may be set. In this instance, the display controller 170 may operate as the first type when a hand is set as the left hand by the user, and may operate as the fourth type when a hand is set as the right hand. When the user makes the wrist-up motion that raises a wrist to check the screen, and the pitch angle of the x axis is about −40 degrees (the movement trajectory of the y axis rotates counterclockwise), the left hand or the right hand may be set. In this instance, the display controller 170 may operate as the third type when a hand is set as the left hand by the user, and may operate as the second type when a hand is set as the right hand.

Referring to FIG. 5D, the user may set a Swipe Direction (SD) based on the wear type. Various functions, such as a back function, may be mapped based on an SD. For example, when the user wears the electronic device in the wear direction of the first type, the SD may be set to a direction from the top side to the bottom side (y→0). When the user wears the electronic device in the wear direction of the second type, the SD may be set to a direction from the top side to the bottom side (−y→0). When the user wears the electronic device in the wear direction of the third type, the SD may be set to a direction from the top side to the bottom side (−y→0). When the user wears the electronic device in the wear direction of the fourth type, the SD may be set to a direction from the top side to the bottom side (y→0).

The user interface settings are not be limited to the above descriptions provided through FIGS. 5A to 5D, and include various user interface settings that are set to be different based on the wear type.

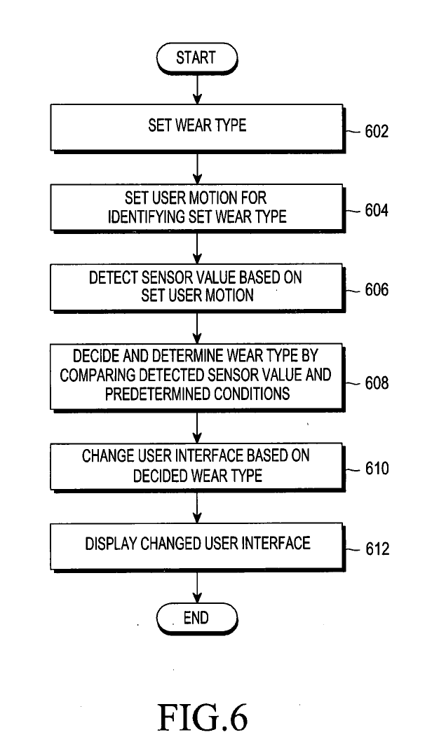

Hereinafter, a user interface providing method of the display controller 170 is described in detail with reference to FIGS. 6 to 9C.

FIG. 6 is a flowchart illustrating a user interface providing method of an electronic device according to an embodiment of the present invention.

Referring to FIG. 6, the display controller 170 sets a plurality of wear types of a user, based on various wear directions of the electronic device 101, in step 602. When the wear types are set, the display controller 170 sets user motions that identify the wear types set by the user, in step 604. The display controller 170 detects a sensor value based on a set user motion in step 606, and decides and determines a wear type, by comparing the detected sensor value and predetermined conditions in step 608. The display controller 170 changes and sets a user interface based on the determined wear type, in step 610. The display controller 170 displays the user interface, which has changed based on the determined wear type, in step 612.

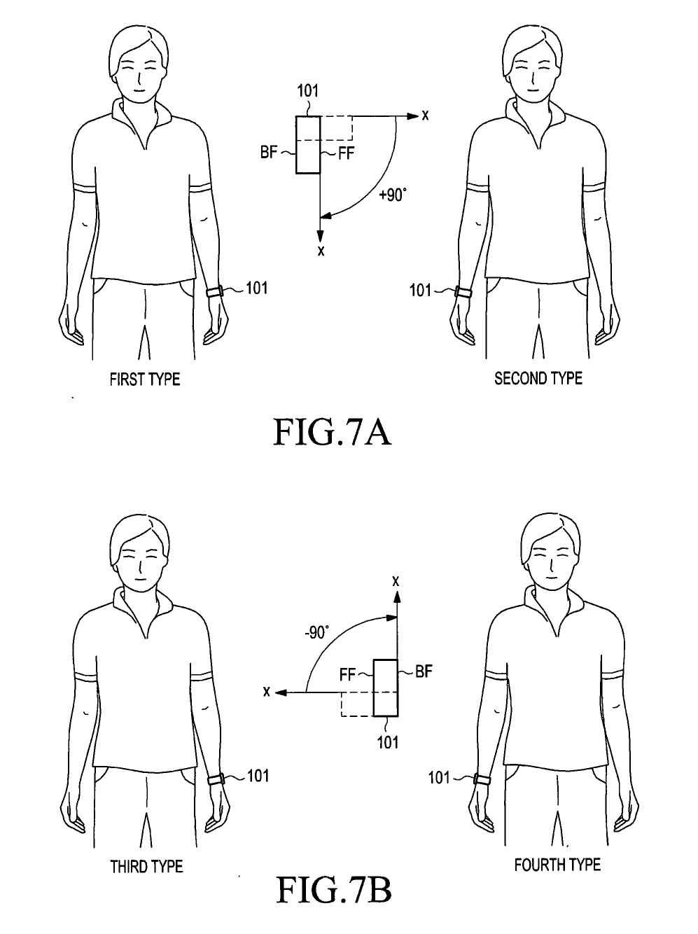

FIGS. 7A and 7B are diagrams illustrating examples of a user motion used for deciding a wear type of an electronic device according to an embodiment of the present invention. In FIGS. 7A and 7B, the front face of the electronic device 101 is expressed as ‘FF’ and the back face of the electronic device 101 is expressed as ‘BB.’ In FIGS. 7A and 7B, a first user motion for identifying a wear type may include a motion that lowers a hand where the electronic device 101 is worn. An x axis may face the upper side or the lower side, according to the first user motion in which the user lowers the hand.

Referring to FIG. 7A, when the x axis faces downward according to the first user motion, in which the user lowers the hand, the wear direction may be identified as one of a first type and a second type. More specifically, the scenario in which the x axis faces the downward according to the first user motion may correspond to the first type (an image on the left) in which the user wears the electronic device on the left hand to enable a virtual reference point P to face the direction of the fingers or the second type (an image on the right) in which the user wears the electronic device on the right hand to enable a virtual reference point P to face the direction of the fingers. In both cases, a movement trajectory of the x axis may rotate 90 degrees clockwise.

Referring to FIG. 7B, when the x axis faces upwards according to the first user motion, in which the user lowers the hand, the wear direction may be identified as one of a third type and a fourth type. More specifically, the scenario in which the x axis faces upward according to the first user motion may correspond to a third type (an image on the left) in which the user wears the electronic device on the left hand to enable a virtual reference point P to face the direction of an arm or a fourth type (an image on the right) in which the user wears the electronic device on the right hand to enable a virtual reference point P to face the direction of the arm. In both cases, the movement trajectory of the x axis may rotate 90 degrees counterclockwise (−90°).

As described above, the display controller 170 decides the wear type as the first type or the second type when a direction that the x axis faces and the trajectory of the x axis are detected as a sensor value associated with the first user motion in which the user lowers the hand, and the positive direction of the x axis faces the downward and the trajectory of the x axis (=the roll angle of the y axis) is a positive value (e.g., 90°), and may decide the wear type as the third type or the fourth type when the positive direction (+) of the x axis faces the upper side and the trajectory of the x axis (=the roll angle of the y axis) is a negative value (e.g., −90°).

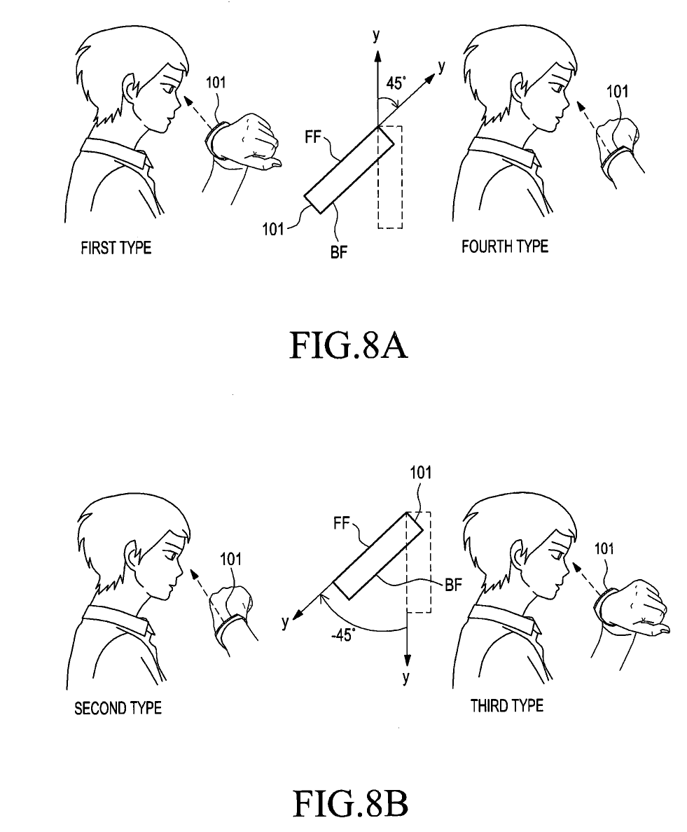

FIGS. 8A and 8B are diagrams illustrating examples of a user motion used for deciding a wear type of an electronic device according to an embodiment of the present invention. In FIGS. 8A and 8B, the front face of the electronic device 101 is expressed as ‘FF’ and the back face of the electronic device 101 is expressed as ‘BB.’ In FIGS. 8A and 8B, a second user motion for identifying a wear type may include a wrist-up motion that includes raising a hand upon which the electronic device 101 is worn. As the user makes the second user motion in which the user raises the wrist to check the screen, the y axis may be tilted about 45 degrees and face the upper side or the lower side.

Referring to FIG. 8A, when the y axis faces upwards while tilting about 45 degrees according to the second user motion in which the user raises the wrist to check the screen may be one of a first type and a fourth type. More specifically, when the y axis faces upwards, tilting about 45 degrees according to the second user motion may correspond to the first type (in which an image is displayed on the left side of the electronic device) in which the user wears the electronic device on the left outer wrist to enable a virtual reference point P to face the direction of the fingers or the fourth type (in which an image is displayed on the right side of the electronic device) in which the user wears the electronic device on the right outer wrist to enable a virtual reference point P to face the direction of the arm. In both cases, a movement trajectory of the y axis may rotate about 45 degrees clockwise.

Referring to FIG. 8B, when the y axis faces the downwards, tilting about −45 degrees according to the second user motion in which the user raises the wrist on which the electronic device is worn to check the screen, the wear type may be one of a second type and a third type. More specifically, when the y axis faces downwards, tilting about −45 degrees according to the second user motion may correspond to the second type (in which an image is displayed on the left of the electronic device) in which the user wears the electronic device on the right outer wrist to enable a virtual reference point P to face the direction of the fingers or the third type (an image on the right) in which the user wears the electronic device on the right outer wrist to enable a virtual reference point P to face the direction of the arm. In both cases, the movement trajectory of the y axis may rotate about 45 degrees counterclockwise (−45°).

As described above, the display controller 170 determines the wear type as the first type or the fourth type when a direction that the y axis faces and the trajectory of the y axis are detected as a sensor value associated with the second user motion in which the user raises the wrist to check the time, and the positive direction (+) of the y axis faces the upper side and the trajectory of the y axis (=the pitch angle of the x axis) is a positive value (e.g., 45°), and may decide the wear type as the second type or the third type when the positive direction (+) of the y axis faces the lower side and the trajectory of the y axis (=the pitch angle of the x axis) is a negative value (e.g., −45°).

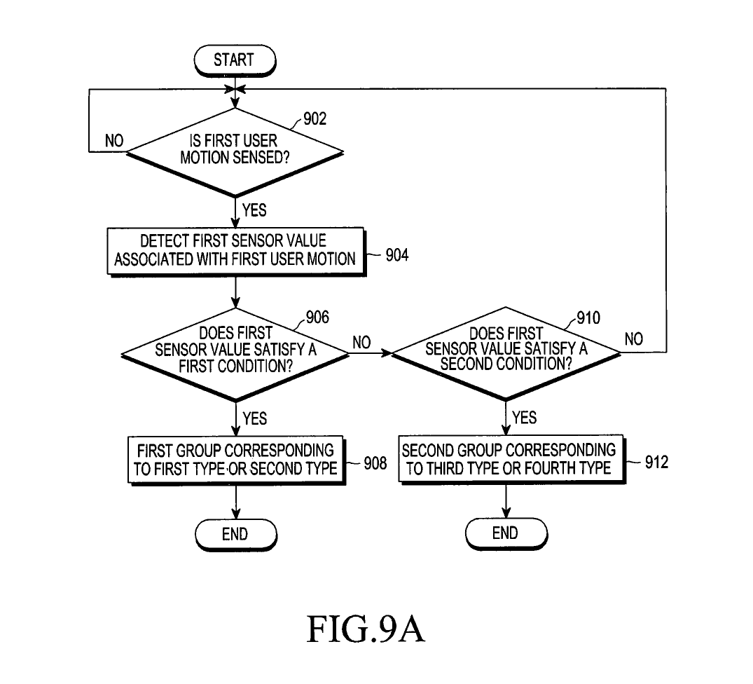

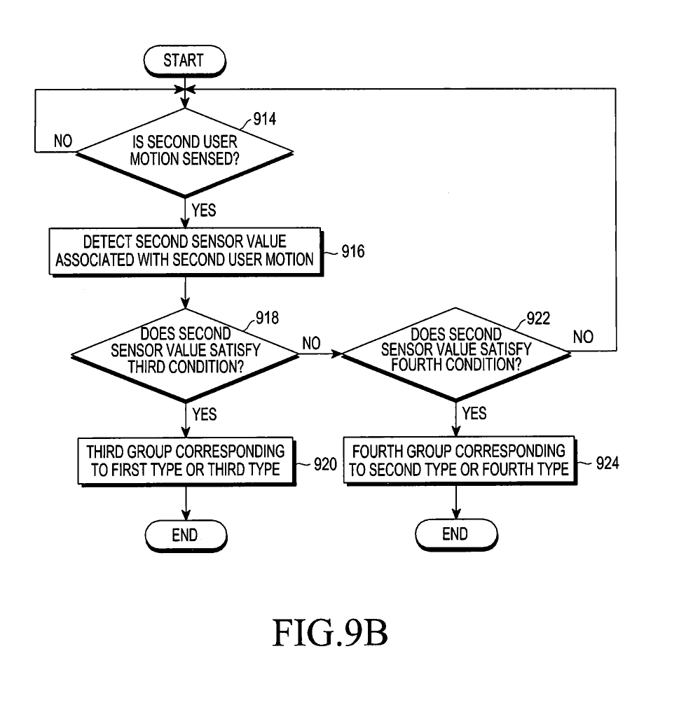

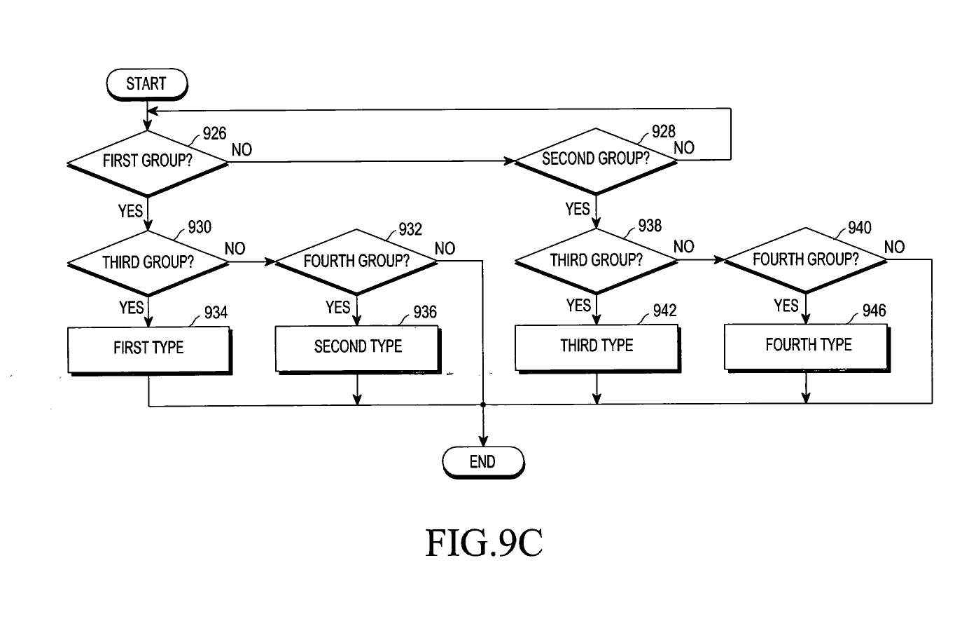

FIGS. 9A through 9C are flowcharts illustrating a process of deciding and determining a wear type of FIG. 6 according to an embodiment of the present invention.

FIG. 9A is a flowchart illustrating an operation of deciding a wear type based on a first user motion. FIG. 9B is a flowchart illustrating an operation of deciding a wear type based on a second user motion. FIG. 9C is a flowchart illustrating an operation of deciding a final wear type by combining decisions based on the first user motion and the second user motion.

Referring to FIG. 9A, the display controller 170 determines whether the first user motion is sensed, in step 902. When the first user motion is sensed, the display controller 170 detects a first sensor value associated with the first user motion, in step 904. When the first user motion is not sensed, in step 902, the display controller 170 continues to monitor whether the first user motion is detected. After detecting the first sensor value, the display controller 170 determines whether the first sensor value satisfies a first condition, in step 906. When the first sensor value satisfies the first condition in step 906, the wear type is determined to be the first type or the second type, and is grouped into a first group, in step 908. Conversely, when the first sensor value does not satisfy the first condition in step 906, the controller 170 determines whether the first sensor value satisfies a second condition, in step 910. When the first sensor value satisfies the second condition in step 910, the wear type is determined to be the third type or the fourth type and is grouped into a second group in step 912, and the process may be terminated. When the first sensor value does not satisfy the second condition in step 910, the process returns to step 902 and repeats subsequent operations.

According to an embodiment of the present invention, the first user motion may be a motion that lowers an arm, the first sensor value is a movement trajectory of the x axis, the first condition is that the movement trajectory of the x axis is a positive value (or clockwise direction), and the second condition is that the movement trajectory of the x axis is a negative value (or counterclockwise direction).

Referring to FIG. 9B, the display controller 170 determines whether the second user motion is detected, in step 914. When the second user motion is sensed, the display controller 170 detects a second sensor value associated with the second user motion, in step 916. When the second user motion is not sensed in step 914, the display controller 170 continues to monitor whether the second user motion is sensed. After detecting the second sensor value, the display controller 170 determines whether the second sensor value satisfies a third condition, in step 918. When the display controller 170 determines that the second sensor value satisfies the third condition in step 918, the wear type is determined to be the first type or the third type and may be grouped into a third group, in step 920. Conversely, when the second sensor value does not satisfy the third condition in step 918, whether the second sensor value satisfies a fourth condition is determined, in step 922. In step 922, when the second sensor value satisfies the fourth condition, the wear type is determined to be the second type or the fourth type and is grouped into a fourth group in step 924, and the process is terminated. When the second sensor value does not satisfy the fourth condition in step 922, the process returns to operation 914 and repeats subsequent operations.

According to an embodiment of the present invention, the second user motion may be a motion that raises the wrist to check the time, the second sensor value is a movement trajectory of the y axis, the third condition is that the movement trajectory of the y axis is a positive value (or clockwise direction), and the fourth condition is that the movement trajectory of the y axis is a negative value (or counterclockwise direction).

Referring to FIG. 9C, the display controller 170 may finally determines the wear type of the user by combining the first to the fourth groups classified through the primary and secondary decisions in FIGS. 9A and 9B. The display controller 170 determines whether a wear type associated with the first sensor value exists in the first group or the second group in the primary decision in steps 926 and 928, and when the wear type exists in the first group in operation 926, decides whether a wear type associated with the second sensor value exists in the third group or the fourth group in the secondary decision in steps 930 and 932. When the corresponding wear type exists in the third group, in step 930, a final wear type of the user may be determined as the first type in step 934. Conversely, when the corresponding wear type does not exist in the third group, in step 930, the display controller 170 determines whether the wear type exists in the fourth group, in step 932, and when the wear type exists in the fourth group, the display controller 170 determines the final wear type of the user as the second type, in step 936. When a corresponding wear type does not exist in the fourth group, in step 932, the process of deciding the wear type of the user is terminated.

When the display controller 170 determines whether the wear type associated with the first sensor value exists in the first group or the second group in the primary decision in steps 926 and 928, and when the wear type exists in the second group in step 928, decides whether the wear type associated with the second sensor value exists in the third group or the fourth group in the secondary decision, in steps 938 and 940. When the wear type associated with the first sensor value does not exist in the second group, in step 928, the process returns to step 926 and repeats subsequent operations. When the corresponding wear type exists in the third group, in step 938, the final wear type of the user may be determined as the third type, in step 942. Conversely, when the corresponding wear type does not exist in the third group, in step 938, the display controller 170 determines whether the wear type exists in the fourth group, in step 940, and when the wear type exists in the fourth group, finally determines that the final wear type of the user as the fourth type, in step 946. When the corresponding wear type does not exist in the fourth group, in step 940, the process of deciding the wear type of the user may be terminated.

According to an embodiment of the present disclosure, a method for an electronic device to provide a user interface may include detecting user motion-based sensor values associated with a plurality of predefined user motions, classifying a wear type of a user into a plurality of predefined groups of a plurality of predefined wear type based on the detected user motion-based sensor values, determining, as the wear type of the user, a predefined wear type that is commonly included in each of the predefined groups into which the wear type of the user is classified, and changing a user interface changed based on the determined wear type of the user.

Also, the user interface providing method of the electronic device according to an embodiment of the present disclosure may further include setting the plurality of wear types and the user motions associated with the plurality of wear types. In this instance, a total of the plurality of predefined wear types is 2ⁿ and n is the number of the plurality of predefined user motions.

According to an embodiment of the present disclosure, when the total of the plurality of predefined wear types is 2², the number of plurality of predefined user motions is determined to be 2, the plurality of wear types may include a first type in which the electronic device is worn on a left outer wrist to enable a first axis of the electronic device to face towards the fingers of a left hand of the user, a second type in which the electronic device is worn on the right outer wrist to enable the first axis to face towards the fingers of a right hand of the user, a third type in which the electronic device is worn on the left outer wrist to enable the first axis to face towards a left arm of the user, and a fourth type in which the electronic device is worn on the right outer wrist to enable the first axis to face towards a right arm of the user, and the plurality of predefined user motions may include a first user motion in which a hand where the electronic device is worn is lowered, and a second user motion in which the hand where the electronic device is on is raised to a position for the user to check a screen of the electronic device.

In this instance, the process of classifying of the wear type of the user into the plurality of groups, may include making a first decision by classifying the wear type of the user into one of a first group and a second group, based on whether a first one of the detected user motion based sensor values associated with a first predefined user motion satisfies a first condition or a second condition, making a second decision by classifying the wear type of the user into one of a third group and a fourth group, based on whether a second one of the detected user motion based sensor values associated with second predefined user motion satisfies a third condition or a fourth condition, and determining as the wear type of the user, a wear type that is commonly included in the one of the first and second groups into which the wear type of the user is classified and the one of the third and fourth groups to which the wear type of the user is classified.

For example, in the case where the first sensor value is a movement trajectory of the first axis, the first condition is that the movement trajectory of the first axis is a positive value, and the second condition is that the movement trajectory of the first axis is a negative value, and wherein making the first decision includes classifying the wear type of the user into the first group comprising the first type and the third type when the detected first sensor value is a positive value, and classifying the wear type of the user into the second group comprising the second type and the fourth type when the detected first sensor value is a negative value.

Also, in the case where the second sensor value is a movement trajectory of a second axis that is perpendicular to the first axis, the third condition is that the movement trajectory of the second axis is a positive value, and the fourth condition is that the movement trajectory of the second axis is a negative value, the second decision includes determining the wear type of the user into the first type or the third type and classifying the wear type of the user into the third group when the detected second sensor value is a positive value, and determining the wear type of the user into the second type or the fourth type and classifying the wear type of the user into the fourth group when the second sensor value is a negative value.

The process of determining the wear type of the user may include determining, as the wear type of the user, the first type, when the wear type of the user is classified into the first group in the first decision and the wear type of the user is classified into the third group in the second decision, determining, as the wear type of the user, the second type when the wear type of the user is classified into the first group in the first decision and the wear type of the user is classified into the fourth group in the second decision, determining the wear type of the user, the third type when the wear type of the user is classified into the second group in the first decision and the wear type of the user is classified into the third group in the second decision, and determining the wear type of the user, the fourth type when the wear type of the user is classified into the second group in the first decision and the wear type of the user is classified into the fourth group in the second decision.

According to an embodiment of the present disclosure, when top and bottom sides or left and right sides of the electronic device are determined in advance based on a reference point formed in one side of the electronic device 101, the total number of the plurality of predefined wear types is 2¹ and the number of the plurality of user motions is 1, wherein the plurality of predefined wear types includes a first type in which the electronic device is worn on a left outer wrist so as to enable a first axis of the electronic device to face towards fingers of a left hand of a user and a fourth type in which the electronic device is worn on a right outer wrist of the user so as to enable the first axis to face towards a right arm of the user, and wherein user motions associated with the first type and the fourth type include a first user motion in which a hand of the user where the electronic device is worn is lowered.

In this instance, the process of determining the wear type of the user may include determining, as the wear type of the user, one of the first type and the fourth type, based on whether a first sensor value detected based on a first predefined user motion satisfies a first condition or a second condition.

For example, the first sensor value is the movement trajectory of the first axis, the first condition is that the movement trajectory of the first axis is a positive value, and the second condition is that the movement trajectory of the first axis is a negative value, wherein determining the wear type of the user further may include determining, as the wear type of the user, the first type when the detected first sensor value is a positive value (for example, 90°), and determining, as the wear type of the user, the fourth type when the detected first sensor value is a negative value (for example, −90°).

According to an embodiment of the present disclosure, when top and bottom sides or left and right sides of the electronic device are determined in advance based on a reference point formed in one side of the electronic device, the total number of the plurality of predefined wear types is 2¹ and the number of the plurality of user motions is 1, wherein the plurality of predefined wear types includes a first type in which the electronic device is worn on the left outer wrist so as to enable a first axis of the electronic device to face towards fingers of a left hand of the user and a fourth type in which the electronic device is worn on the right outer wrist so as to enable the first axis to face toward a right arm of the user, and wherein user motions associated with the first type and the fourth type include a second user motion in which a wrist of the user where the electronic device is worn is raised to check a screen of the electronic device.

In this instance, the process of determining the wear type of the user includes determining, as the wear type of the user, one of the first type and the fourth type, based on whether a second sensor value detected based on second predefined user motion satisfies a third condition or a fourth condition.

For example, the second sensor value is a movement trajectory of a second axis that is perpendicular to the first axis, the third condition is that the movement trajectory of the second axis is a positive value, and the fourth condition is that the movement trajectory of the second axis is a negative value, wherein determining the wear type of the user further may include determining, as the wear type of the user, the first type when the detected second sensor value is a positive value (for example, 45°), and determining, as the wear type of the user, the fourth type when the detected second sensor value is a negative value (for example, −45°).

Also, the user interface providing method of the electronic device, according to an embodiment of the present disclosure, may further include displaying the changed a user interface.

According to an embodiment of the present disclosure, the process of changing the user interface includes at least one of a screen direction, a location of an input button, a selection of one of a left and right hand of the user during a motion of raising a wrist and checking a screen, and a swipe direction (SD).

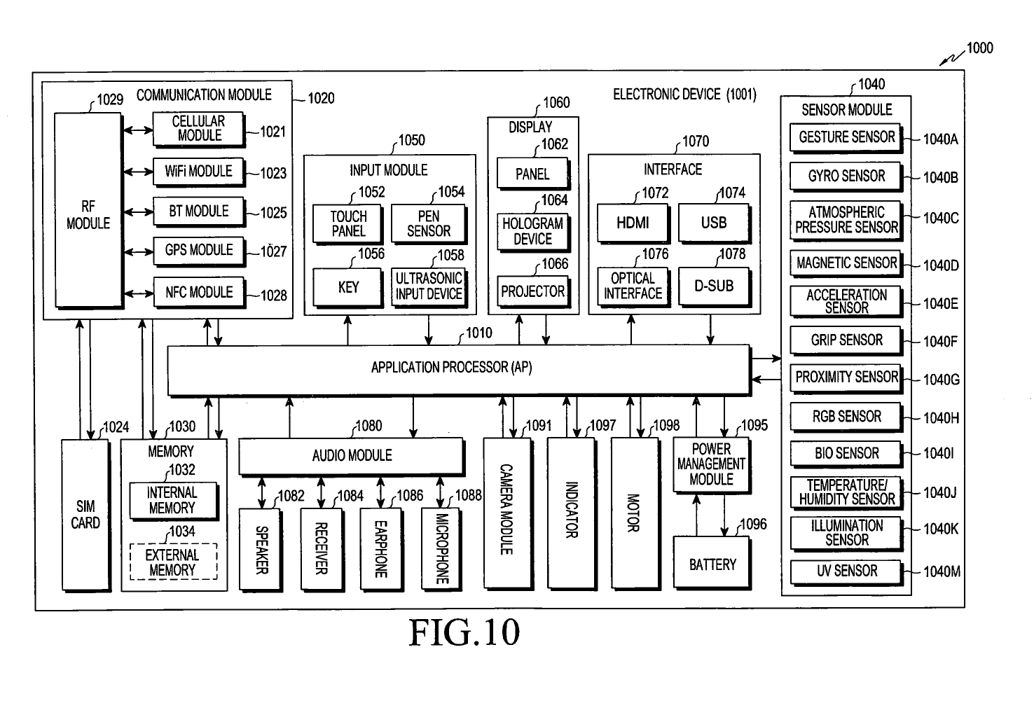

FIG. 10 is a block diagram of an electronic device according to various embodiments of the present invention.

Referring to FIG. 10, an electronic device 1001 may form, for example, some or all of the electronic device 101 illustrated in FIG. 1.

The electronic device 1001 includes an Application Processor (AP) 1010, a communication module 1020, a Subscriber Identifier Module (SIM) card 1024, a memory 1030, a sensor module 1040, an input module 1050, a display 1060, an interface 1070, an audio module 1080, a camera module 1091, a power management module 1095, a battery 1096, an indicator 1097, and a motor 1098.

The AP 1010 controls a plurality of hardware or software component elements connected thereto by driving an operating system or an application program, processes various types of data including multimedia data, and performs calculations. The AP 1010 may be embodied as, for example, a System On Chip (SoC). According to an embodiment of the present invention, the AP 1010 may further include a Graphic Processing Unit (GPU).

The communication module 1020 (e.g., the communication interface 160) performs data transmission/reception in communication between the electronic device 1001 (e.g., the electronic device 101) and other electronic devices (e.g., the electronic device 104 and the server 106) connected over a network. The communication module 1020 includes a cellular module 1021, a WiFi module 1023, a BlueTooth (BT) module 1025, a Global Positioning System (GPS) module 1027, a Near Field Communication (NFC) module 1028, and a Radio Frequency (RF) module 1029.

The cellular module 1021 provides voice calls, video calls, a text service, an Internet service, and the like through a communication network (e.g., LTE, LTE-A, CDMA, WCDMA, UMTS, WiBro, GSM, or the like). Also, the cellular module 1021 identifies and authenticates an electronic device in a communication network by using, for example, a subscriber identification module (e.g., the SIM card 1024). According to an embodiment of the present invention, the cellular module 1021 may perform at least some of the functions which may be provided by the AP 1010. For example, the cellular module 1021 may perform at least a part of a multimedia control function.

According to an embodiment of the present invention, the cellular module 1021 may include a Communication Processor (CP). Further, the cellular module 1021 may be embodied as, for example, an SoC. Although the component elements such as the cellular module 1021 (e.g., the communication processor), the memory 1030, the power management module 1095, and the like are illustrated to be separate from the AP 1010 in FIG. 10, the AP 1010 may be implemented to include at least some of the above described elements (e.g., the cellular module 1021) according to one embodiment.

According to an embodiment of the present invention, the AP 1010 or the cellular module 1021 (e.g., communication processor) may load a command or data received from at least one of a non-volatile memory and other component elements connected to each of the AP 1010 and the cellular module 1021 to a volatile memory and process the loaded command or data. Further, the AP 1010 or the cellular module 1021 may store data received from or generated by at least one of the other component elements in a non-volatile memory.

Each of the Wi-Fi module 1023, the BT module 1025, the GPS module 1027, and the NFC module 1028 may include, for example, a processor for processing data transmitted/received through the corresponding module. Although the cellular module 1021, the Wi-Fi module 1023, the BT module 1025, the GPS module 1027, and the NFC module 1028 are illustrated as individual blocks in FIG. 10, two or more of the cellular module 1021, the Wi-Fi module 1023, the BT module 1025, the GPS module 1027, and the NFC module 1028 may be included within one Integrated Chip (IC) or one IC package. For example, some processors corresponding to the cellular module 1021, the Wi-Fi module 1023, the BT module 1025, the GPS module 1027, and the NFC module 1028, respectively, may be embodied as one SoC.

The RF module 1029 transmits/receives data via an RF signal. Although not illustrated, the RF module 1029 may include, for example, a transceiver, a Power Amp Module (PAM), a frequency filter, a Low Noise Amplifier (LNA), or the like. The RF module 1029 may further include components, for example, a conductor or a cable for transmitting and receiving electromagnetic waves through a free space in wireless communication. Although the cellular module 1021, the Wi-Fi module 1023, the BT module 1025, the GPS module 1027, and the NFC module 1028 are illustrated to share one RF module 1029 in FIG. 10, one or more of the cellular module 1021, the Wi-Fi module 1023, the BT module 1025, the GPS module 1027, and the NFC module 1028 may transmit/receive the RF signal through a separate RF module.

The SIM card 1024 may be inserted into a slot formed in a particular portion of the electronic device. The SIM card 1024 includes unique identification information (e.g., an Integrated Circuit Card IDentifier (ICCID)) or subscriber information (e.g., an International Mobile Subscriber Identity (IMSI)).

The memory 1030 (e.g., the memory 130) includes an embedded memory 1032 or an external memory 1034. The internal memory 1032 may include at least one of a volatile memory (e.g., a Dynamic Random Access Memory (DRAM), a Static RAM (SRAM), a Synchronous Dynamic RAM (SDRAM), and the like) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, and the like).

According to an embodiment of the present invention, the embedded memory 1032 may be a Solid State Drive (SSD). The external memory 1034 may further include a flash drive, for example, a Compact Flash (CF), a Secure Digital (SD), a Micro Secure Digital (Micro-SD), a Mini Secure Digital (Mini-SD), an extreme Digital (xD), a memory stick or the like. The external memory 1034 may be functionally connected to the electronic device 1001 through various interfaces. According to an embodiment of the present invention, the electronic device 1001 may further include a storage device (or storage medium) such as a hard drive.

The sensor module 1040 measures a physical quantity or detects an operation state of the electronic device 1001, and converts the measured or detected information to an electric signal. The sensor module 1040 includes a gesture sensor 1040A, a gyro sensor 1040B, an atmospheric pressure sensor 1040C, a magnetic sensor 1040D, an acceleration sensor 1040E, a grip sensor 1040F, a proximity sensor 1040G, a color sensor 1040H (e.g., a Red/Green/Blue (RGB) sensor), a biometric sensor 1040I, a temperature/humidity sensor 1040J, an illumination sensor 1040K, and an Ultra Violet (UV) sensor 1040M. The sensor module 1040 may also include, for example, an E-nose sensor, an ElectroMyoGraphy (EMG) sensor, an ElectroEncephaloGram (EEG) sensor, an ElectroCardioGram (ECG) sensor, an InfraRed (IR) sensor, an iris sensor, or a fingerprint sensor. The sensor module 1040 may further include a control circuit for controlling at least one sensor included in the sensor module 1040.

The input module 1050 includes a touch panel 1052, a (digital) pen sensor 1054, a key 1056, or an ultrasonic input device 1058. The touch panel 1052 may recognize a touch input through at least one of, for example, a capacitive scheme, a resistive scheme, an infrared scheme, and an ultrasonic scheme. Also, the touch panel 1052 may further include a control circuit. A capacitive touch panel may recognize a physical contact or proximity. The touch panel 1052 may further include a tactile layer. In this instance, the touch panel 1052 may provide a tactile reaction to a user.

The (digital) pen sensor 1054 may be embodied, for example, using a method identical or similar to a method of receiving a touch input of a user, or using a separate recognition sheet. The key 1056 may include, for example, a physical button, an optical key or a keypad. The ultrasonic input device 1058 is a device that generates an ultrasonic signal through an input tool, and identifies data by detecting a sonic wave through a microphone (e.g., microphone 1088) in the electronic device 1001, and is capable of wireless recognition. According to an embodiment of the present invention, the electronic device 1001 may receive a user input from an external device (e.g., computer or server) connected to the electronic device 1001 using the communication module 1020.

The display 1060 (e.g., the display 150) includes a panel 1062, a hologram device 1064, and a projector 1066. The panel 1062 may be, for example, a Liquid Crystal Display (LCD), Active-Matrix Organic Light Emitting Diode (AM-OLED), or the like. The panel 1062 may be embodied to be, for example, flexible, transparent, or wearable. The panel 1062 may also be configured as a single module integrated with the touch panel 1052. The hologram device 1064 may show a stereoscopic image in the air by using interference of light. The projector 1066 may project light onto a screen to display an image. For example, the screen may be located inside or outside the electronic device 1001. According to an embodiment of the present invention, the display 1060 may further include a control circuit for controlling the panel 1062, the hologram device 1064, or the projector 1066.

The interface 1070 includes a High-Definition Multimedia Interface (HDMI) 1072, a Universal Serial Bus (USB) 1074, an optical interface 1076, or a D-subminiature (D-sub) 1078. The interface 1070 may be included in, for example, the communication interface 160 illustrated in FIG. 1. The interface 1070 may also include, for example, a Mobile High-definition Link (MHL) interface, a Secure Digital (SD) card/Multi-Media Card (MMC) interface, or an Infrared Data Association (IrDA) standard interface.

The audio module 1080 bidirectionally converts a sound and an electric signal. At least some component elements of the audio module 1080 may be included in, for example, the input/output interface 140 illustrated in FIG. 1. The audio module 1080 may process voice information input or output through, for example, a speaker 1082, a receiver 1084, earphones 1086, the microphone 1088 or the like.

The camera module 1091 is a device for capturing a still image or a video, and according to an embodiment of the present invention, may include one or more image sensors (e.g., a front sensor or a rear sensor), a lens (not illustrated), an Image Signal Processor (ISP) (not illustrated), or a flash (not illustrated) (e.g., an LED or xenon lamp).

The power management module 1095 manages power of the electronic device 1001. Although not illustrated, the power management module 1095 may include, for example, a Power Management Integrated Circuit (PMIC), a charger Integrated Circuit (IC), or a battery gauge.

The PMIC may be mounted to, for example, an integrated circuit or an SoC semiconductor. Charging methods may be classified into a wired charging method and a wireless charging method. The charger IC may charge a battery and prevent over voltage or over current from a charger. According to an embodiment of the present invention, the charger IC may include a charger IC for at least one of the wired charging method and the wireless charging method. Examples of the wireless charging may include magnetic resonance charging, magnetic induction charging, and electromagnetic charging, and an additional circuit such as a coil loop, a resonance circuit, and a rectifier may be added for the wireless charging.

The battery gauge may measure, for example, the residual quantity 1096 of a battery, a charging voltage and current, or temperature. The battery 1096 stores or generates electricity, and supplies power to the electronic device 1001 using the stored or generated electricity. The battery 1096 may include, for example, a rechargeable battery or a solar battery.

The indicator 1097 display a particular status of the electronic device 1001 or a part thereof (e.g., the AP 1410), for example, a booting status, a message status, a charging status, or the like. The motor 1098 may convert an electric signal to a mechanical vibration. Although not shown, the electronic device 1001 may include a processing device (e.g., GPU) for supporting a mobile TV function. The processing device for supporting mobile TV may process media data according to a standard of Digital Multimedia Broadcasting (DMB), Digital Video Broadcasting (DVB), media flow or the like.

The above described components of the electronic device according to various embodiments of the present invention may be formed of one or more components, and a name of a corresponding component element may be changed based on the type of electronic device. The electronic device according to the present invention may include one or more of the aforementioned components or may further include other additional components, or some of the aforementioned components may be omitted. Further, some of the components of the electronic device according to the various embodiments of the present invention may be combined to form a single entity, and thus, may equivalently execute functions of the corresponding elements prior to the combination.

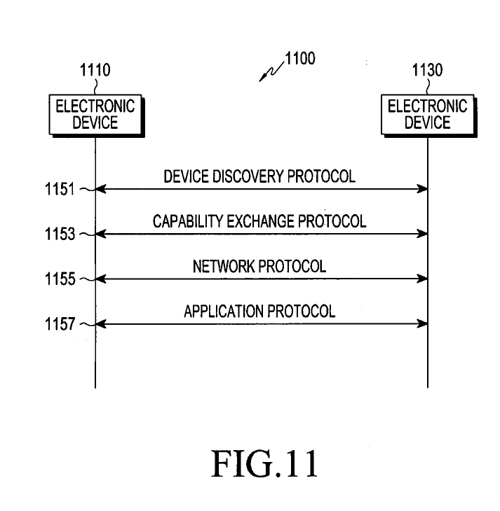

FIG. 11 illustrates a communication protocol among a plurality of electronic devices according to an embodiment of the present invention.

Referring to FIG. 11, for example, a communication protocol 1100 used between an electronic device 1110 and an electronic device 1130 includes a device discovery protocol 1151, a capability exchange protocol 1153, a network protocol 1155, an application protocol 1157, and the like.

According to an embodiment of the present invention, the device discovery protocol 1151 is a protocol used when one of the electronic devices (i.e., the electronic device 1110 or the electronic device 1130) detects another external electronic device that can communicate with the electronic device or establishes a connection with the detected external electronic device. For example, the electronic device 1110 (e.g., the electronic device 101) may detect the electronic device 1130 (e.g., the electronic device 104) as a device that is capable of communicating with the electronic device 1110 through a communication method (e.g., WiFi, BT, USB, etc.) which may be used by the electronic device 1110 using the device discovery protocol 1151. In order to establish a communication connection with the electronic device 1130, the electronic device 1110 may acquire identification information of the electronic device 1130 detected through the device discovery protocol 1151, and store the acquired identification information. For example, the electronic device 1110 may establish a communication connection with the electronic device 1130 based on at least the identification information.

According to an embodiment of the present invention, the device discovery protocol 1151 is a protocol for a mutual authentication among a plurality of electronic devices. For example, the electronic device 1110 performs authentication between the electronic device 1110 and the electronic device 1130, based on communication information (e.g., a Media Access Control (MAC) address, a Universally Unique IDentifier (UUID), a SubSystem IDentification (SSID), and an Information Provider (IP) address) for the connection with the electronic device 1130.

According to an embodiment of the present invention, the capability exchange protocol 1153 is a protocol for exchanging information related to a service function that is supported by at least one of the electronic device 1110 and the electronic device 1130. For example, the electronic device 1110 and the electronic device 1130 may exchange information related to a service function currently provided by each of the electronic device 1110 and the electronic device 1030 through the capability exchange protocol 1153. The exchangeable information may include identification information indicating a particular service among a plurality of services which can be supported by the electronic device 1110 or the electronic device 1130. For example, the electronic device 1110 may receive identification information of a particular service provided by the electronic device 1130, from the electronic device 1130 through the capability exchange protocol 1153. In this instance, the electronic device 1110 determines whether the electronic device 1110 supports the particular service, based on the received identification information.

According to an embodiment of the present invention, the network protocol 1155 controls flows of data that are transmitted/received to provide a service through interworking between the electronic devices (e.g., the electronic device 1110 and the electronic device 1130) which are connected to communicate with each other. For example, at least one of the electronic device 1110 and the electronic device 1130 may control an error or data quality using the network protocol 1155. Additionally or alternatively, the network protocol 1155 may determine a transmission format of data transmitted/received between the electronic device 1110 and the electronic device 1130. Further, at least one of the electronic device 1110 and the electronic device 1130 manages a session (e.g., connects or terminates a session) for exchanging data between the electronic devices by using the network protocol 1155.

According to an embodiment of the present invention, the application protocol 1157 provides a process or information for exchanging data related to a service provided to an external electronic device. For example, the electronic device 1110 (e.g., the electronic device 101) may provide a service to the electronic device 1130 (e.g., the electronic device 104 or the server 106) through the application protocol 1157.

According to an embodiment of the present invention, the communication protocol 1100 includes a standard communication protocol, a communication protocol designated by an individual or organization (e.g., a communication protocol self-designated by a communication device manufacturing company, a network supplying company, or the like) or a combination thereof.

The term “module”, as used herein, may refer to, for example, a “unit” including one of hardware, software, and firmware, or a combination thereof. The term “module” may be interchangeably used with terms, such as “unit”, “logic”, “logical block”, “component”, or “circuit”. A “module” may be the smallest unit of an integrated component or a part thereof. A “module” may be the smallest unit that performs one or more functions or a part thereof. A “module” may be mechanically or electronically implemented. For example, the “module”, according to an embodiment of the present invention may include at least one of an Application-Specific Integrated Circuit (ASIC) chip, a Field-Programmable Gate Arrays (FPGAs), and a programmable-logic device for performing operations which have been known or are to be developed hereafter.

According to various embodiments of the present invention, at least a part of a device (e.g., modules or functions thereof) or a method (e.g., operations) according to the various embodiments of the present invention may be embodied by, for example, a command stored in a non-transitory computer readable storage medium in a form of a programming module. When the instruction is performed by at least one processor (e.g., the processor 120), the at least one processor may perform a function corresponding to the instruction. The computer-readable storage medium may be, for example, the memory 130. At least some of the programming modules may be implemented (e.g., executed) by, for example, the processor 120. At least a part of the programming module may, for example, include a module, a program, a routine, a set of instructions, or a process for performing at least one function.

The computer readable recording medium may include magnetic media such as a hard disc, a floppy disc, and a magnetic tape, optical media such as a Compact Disc Read Only Memory (CD-ROM) and a Digital Versatile Disc (DVD), magneto-optical media such as a floptical disk, and hardware devices specifically configured to store and execute program commands, such as a Read Only Memory (ROM), a Random Access Memory (RAM), and a flash memory. In addition, the program instructions may include high class language codes, which can be executed in a computer by using an interpreter, as well as machine codes made by a compiler. The aforementioned hardware device may be configured to operate as one or more software modules in order to perform the operation of various embodiments of the present invention, and vice versa.

A module or a programming module according to the present invention may include at least one of the described component elements, a few of the component elements may be omitted, or additional component elements may be included. Operations executed by a module, a programming module, or other component elements according to various embodiments of the present invention may be executed sequentially, in parallel, repeatedly, or in a heuristic manner. Further, some operations may be executed according to another order or may be omitted, or other operations may be added.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. An electronic device, comprising:
a sensor unit configured to detect user motion-based sensor values associated with a plurality of predefined user motions; and
a controller configured to:
classify a wear type of a user into a plurality of predefined groups based on the detected user motion-based sensor values,
determine, as the wear type of the user, a predefined wear type that is commonly included in each of the predefined groups into which the wear type of the user is classified, and
to control a change of a user interface based on the determined wear type of the user.

2. The electronic device of claim 1, wherein the number of the plurality of predefined wear types is determined to be 2ⁿ and n is the number of the plurality of predefined user motions.

3. The electronic device of claim 1, wherein the plurality of wear types includes:
a first type in which the electronic device is worn on a left outer wrist of the user, so as to enable a first axis of the electronic device to face towards fingers of a left hand of the user,
a second type in which the electronic device is worn on a right outer wrist of the user, so as to enable the first axis to face towards fingers of a right hand of the user,
a third type in which the electronic device on a left outer wrist of the user, so as to enable the first axis to face towards a left arm of the user, and
a fourth type in which the electronic device is worn on a right outer wrist of the user, so as to enable the first axis to face a right arm of the user, and wherein the plurality of predefined user motions includes:
a first user motion in which a hand where the electronic device is worn is lowered, and
a second user motion in which a wrist where the electronic device is worn to check a screen is raised.

4. The electronic device of claim 1, wherein the controller is further configured to:
make a first decision by classifying the wear type of the user into one of a first group and a second group, based on whether a first one of the detected user motion-based sensor values associated with a first predefined user motion satisfies a first condition or a second condition;
make a second decision by classifying the wear type of the user, into one of a third group and a fourth group, based on whether a second one of the detected user-motion based sensor values associated with a second predefined user motion satisfies a third condition or a fourth condition; and
determining, as the wear type of the user, a wear type that is commonly included in the one of the first and second groups into which the wear type of the user is classified and the one of the third and fourth groups to which the wear type of the user is classified.

5. The electronic device of claim 4, wherein the first sensor value is a movement trajectory of the first axis, the first condition is that the movement trajectory of the first axis is a positive value, and the second condition is that the movement trajectory of the first axis is a negative value,
wherein in making the first decision, the controller is further configured to classify the wear type of the user into the first group comprising a first type and a second type when the detected first sensor value is a positive value, and classify the wear type of the user into the second group comprising a third type and a fourth type when the detected first sensor value is a negative value,
wherein the second sensor value is a movement trajectory of a second axis that is perpendicular to the first axis, the third condition is that the movement trajectory of the second axis is a positive value, and the fourth condition is that the movement trajectory of the second axis is a negative value, and
wherein in making the second decision, the controller is further configured to classify the wear type of the user into the third group comprising the first type and the third type when the detected second sensor value is a positive value, and classify the wear type of the user into the fourth group comprising the second type and the fourth type when the second sensor value is a negative value.

6. The electronic device of claim 4, wherein the controller is further configured to:
determine, as the wear type of the user, the first type, when the wear type of the user is classified into the first group in the first decision and the wear type of the user is classified into the third group in the second decision;
determine, as the wear type of the user, the second type, when the wear type of the user is classified into the first group in the first decision and the wear type of the user is classified into the fourth group in the second decision;
determine, as the wear type of the user, the third type, when the wear type of the user is classified into the second group in the first decision and the wear type of the user is classified into the third group in the second decision; and
determine, as the wear type of the user, the fourth type, when the wear type of the user is classified into the second group in the first decision and the wear type of the user is classified into the fourth group in the second decision.

7. The electronic device of claim 2, wherein, when top and bottom sides or left and right sides of the electronic device are determined in advance based on a reference point formed in one side of the electronic device, the total number of the plurality of predefined wear types is 2 and the number of the plurality of user motions is 1,
wherein the plurality of predefined wear types includes a first type in which the electronic device is worn on a left outer wrist of a user so as to enable a first axis of the electronic device to face towards fingers of a left hand of the user and a fourth type in which the electronic device is worn on a right outer wrist of the user so as to enable the first axis to face towards a right arm of the user, and
wherein user motions associated with the first type and the fourth type include a first user motion in which a hand of the user where the electronic device is worn is lowered.

8. The electronic device of claim 7, wherein the controller is further configured to determine, as the wear type of the user, one of the first type and the fourth type, based on whether the first sensor value detected based on a first predefined user motion satisfies a first condition or a second condition.

9. The electronic device of claim 8, wherein the first sensor value is a movement trajectory of the first axis, the first condition is that the movement trajectory of the first axis is a positive value, and the second condition is that the movement trajectory of the first axis is a negative value, and
wherein the controller is further configured to:
determine, as the wear type of the user, the first type when the detected first sensor value is a positive value; and
determine, as the wear type of the user, the fourth type when the detected first sensor value is a negative value.

10. The electronic device of claim 2, wherein the plurality of wear types includes a first type in which the electronic device on s left outer wrist of the user so as to enable a first axis of the electronic device to face towards fingers of a left hand of the user and a fourth type in which the electronic device is worn on a right outer wrist of the user so as to enable the first axis to face towards a right arm of the user, and
wherein user motions associated with the first type and the fourth type include a 25 second user motion in which a wrist of the user where the electronic device is worn is raised to check a screen of the electronic device.

11. A method for an electronic device to provide a user interface, the method comprising:
detecting user motion-based sensor values associated with a plurality of predefined user motions;
classifying a wear type of a user into a plurality of predefined groups of a plurality of predefined wear types based on the detected user motion-based sensor values;
determining, as the wear type of the user, a predefined wear type that is commonly included in each of the predefined groups into which the wear type of the user is classified; and
changing a user interface changed based on the determined wear type of the user.

12. The method of claim 11, wherein a total number of the plurality of predefined wear types is 2ⁿ and n is the number of the plurality of predefined user motions.

13. The method of claim 11, wherein the plurality of wear types includes:
a first type in which the electronic device is worn on a left outer wrist of the user, so as to enable a first axis of the electronic device to face towards fingers of a left hand of the user,
a second type in which the electronic device is worn on a right outer wrist of the user, so as to enable the first axis to face towards fingers of a right hand of the user,
a third type in which the electronic device is worn on the left outer wrist, so as to enable the first axis to face towards a left arm of the user, and
a fourth type in which the electronic device is worn on the right outer wrist so as to enable the first axis to face towards a right arm of the user, and wherein the plurality of predefined user motions includes:
a first user motion in which a hand where the electronic device is worn is lowered, and
a second user motion in which the hand where the electronic device is worn is raised to a position for the user to check a screen of the electronic device.

14. The method of claim 11, wherein classifying the wear type of the user into the plurality of groups, comprises:
making a first decision by classifying the wear type of the user into one of a first group and a second group, based on whether a first one of the detected user motion-based sensor values associated with a first predefined user motion satisfies a first condition or a second condition;
making a second decision by classifying the wear type of the user into one of a third group and a fourth group, based on whether a second one of the detected user-motion based sensor values associated with a second predefined user motion satisfies a third condition or a fourth condition; and
determining, as the wear type of the user, a wear type that is commonly included in the one of the first and second groups into which the wear type of the user is classified and the one of the third and fourth groups to which the wear type of the user is classified.

15. The method of claim 14, wherein, the first sensor value is a movement trajectory of the first axis, the first condition is that the movement trajectory of the first axis is a positive value, and the second condition is that the movement trajectory of the first axis is a negative value, and
wherein making the first decision comprises:
classifying the wear type of the user into the first group comprising a first type and a second type when the detected first sensor value is a positive value; and
classifying the wear type of the user into the second group comprising a third type and a fourth type when the detected first sensor value is a negative value.

16. The method of claim 15, wherein, the second sensor value is a movement trajectory of a second axis that is perpendicular to the first axis, the third condition is that the movement trajectory of the second axis is a positive value, and the fourth condition is that the movement trajectory of the second axis is a negative value, and
wherein making the second decision comprises:
classifying the wear type of the user into the third group comprising the first type and the third type when the detected second sensor value is a positive value; and
classifying the wear type of the user into the fourth group comprising the second type and the fourth type when the second sensor value is a negative value.

17. The method of claim 16, wherein determining the wear type of the user comprises:
determining, as the wear type of the user, the first type, when the wear type of the user is classified into the first group in the first decision and the wear type of the user is classified into the third group in the second decision;
determining, as the wear type of the user, the second type when the wear type of the user is classified into the first group in the first decision and the wear type of the user is classified into the fourth group in the second decision;
determining, as the wear type of the user, the third type when the wear type of the user is classified into the second group in the first decision and the wear type of the user is classified into the third group in the second decision; and
determining, as the wear type of the user, the fourth type when the wear type of the user is classified into the second group in the first decision and the wear type of the user is classified into the fourth group in the second decision.

18. The method of claim 12, wherein, when top and bottom sides or left and right sides of the electronic device are determined in advance based on a reference point formed in one side of the electronic device, the total number of the plurality of predefined wear types is 2 and the number of the plurality of user motions is 1,
wherein the plurality of predefined wear types includes a first type in which the electronic device is worn on a left outer wrist so as to enable a first axis of the electronic device to face towards fingers of a left hand of a user and a fourth type in which the electronic device is worn on a right outer wrist of the user so as to enable the first axis to face towards a right arm of the user, and
wherein user motions associated with the first type and the fourth type include a first user motion in which a hand of the user where the electronic device is worn is lowered.

19. The method of claim 18, wherein determining the wear type of the user comprises:
determining, as the wear type of the user, one of the first type and the fourth type, based on whether a first sensor value detected based on a first predefined user motion satisfies a first condition or a second condition.

20. The method of claim 12, wherein, when top and bottom sides or left and right sides of the electronic device are determined in advance based on a reference point formed in one side of the electronic device, the total number of the plurality of predefined wear types is 2 and the number of the plurality of predetermined user motions is 1,
wherein the plurality of predefined wear types includes a first type in which the electronic device is worn on a left outer wrist so as to enable a first axis of the electronic device to face towards fingers of a left hand of the user and a fourth type in which the electronic device is worn on a right outer wrist of the user so as to enable the first axis to face towards a right arm of the user, and
wherein user motions associated with the first type and the fourth type include a second user motion in which a wrist of the user where the electronic device is worn is raised to check a screen of the electronic device.
